(19) United States
(12) Patent Application Publication
(10) Pub. No.: US 2018/0047169 A1
(43) Pub. Date: Feb. 15, 2018

(54) METHOD AND APPARATUS FOR EXTRACTING OBJECT FOR STICKER IMAGE

(71) Applicant: MACRON CO., LTD., SEONGNAM (KR)

(72) Inventor: KIL-JAE LEE, SEONGNAM (KR)

(73) Assignee: MACRON CO., LTD.

(21) Appl. No.: 15/617,054

(22) Filed: Jun. 8, 2017

(30) Foreign Application Priority Data
Aug. 11, 2016 (KR) 10-2016-0102434

(51) Int. Cl. G06T 7/11; G06T 7/73; G06T 7/194

(52) U.S. Cl. CPC G06T 7/11; G06T 7/194; G06T 7/73; G06T 7/97

(57) ABSTRACT

Provided is a method and apparatus for extracting an object for a sticker image. The method includes obtaining a first image and a second image by using a first camera, obtaining a third image by using a second camera, determining an object region by using a difference image between the first image and the second image, extracting an object region image that corresponds to the determined object region from the third image, and superimposing by overlaying the extracted object region image with a background image.

### CROSS-REFERENCE TO RELATED PATENT APPLICATION

This application claims the benefit of Korean Patent Application No. 10-2016-0102434, filed on Aug. 11, 2016, the disclosure of which is incorporated herein in its entirety by reference.

### BACKGROUND

### 1. Technical Field

The present invention relates to a method and apparatus for extracting an object for a sticker image, and more particularly, to a method and apparatus for extracting an object for a sticker image superimposed on a real-time background image after extracting an object by using a difference image obtained through an infrared camera. In addition, the present invention relates to method and apparatus for attaching a sticker, and more particularly, to a method and apparatus for automatically attaching a sticker after determining a sticker according to a shape, a location, an angle or a position of an object.

### 2. Related Art

Since smart phones are developed, superimposition of images, which was generally done by experts, may be available by smart phone users and the users are interested in various superimposition methods. In particular, as recognition technology is developed, fun superimposition methods based on recognition may be used.

Recently, technology for extracting an object image except for a background and superimposing the extracted image on another background comes out. Such technology is frequently used in a broadcast screen. However, in order to extract an object image, image segmentation is required and may not be automatically performed. In general, an object is extracted manually or a specific-colored chromakey cloth is used as a background to extract an object with a feature of color.

Here, when an object is extracted manually, the time required is great. Also, a chromakey cloth is to be prepared in advance so that time and effort is needed to create a situation and creating of the situation is not available in real-time.

In addition, applications for overlapping stickers on a specific position according to a location of a face are recently released. However, users experience inconvenience in that the users in person need to decide stickers beforehand off-line. Also, technology of replacing or changing stickers according to a change of an object does not currently exist.

### SUMMARY

The present invention provides a method and apparatus for automatically extracting a real-time object and superimposing the extracted object on a background image without using a chromakey cloth after obtaining a difference image through infrared irradiation and using the difference image in extracting of the object.

The present invention also provides a method and apparatus for attaching various stickers on desired positions according to a shape, a location, an angle or a position of an object.

According to an aspect of the present invention, there is provided a method of extracting an object for a sticker image including: obtaining a first image and a second image by using a first camera; obtaining a third image by using a second camera; determining an object region by using a difference image between the first image and the second image; extracting an object region image that corresponds to the determined object region from the third image; and superimposing by overlaying the extracted object region image with a background image.

The first camera may be an infrared camera and the second camera may be a RGB camera and the first image may be an image obtained by using an infrared camera by irradiating an infrared light and the second image may be an image obtained by using an infrared camera without irradiating an infrared light.

The determining an object region by using a difference image between the first image and the second image may include determining a region, in which a bright change obtained after subtracting the second image from the first image is below a fixed critical value, as a background region and a region, in which the bright change is above a fixed critical value, as an object region and the extracting an object region image that corresponds to the determined object region from the third image may include extracting an object region image except for the region that corresponds to the background region determined from the third image.

A focus of the first camera and a focus of the second camera may be placed at the same axis by using a half mirror.

The method may further include changing the background image when motion of any one of the first camera and the second camera is sensed.

The object region image may be a hand image and the background image may be a menu.

According to another aspect of the present invention, there is provided an apparatus for extracting on object for a sticker image including: an image obtaining unit comprising a first camera, which obtains a first image and a second image, and a second camera, which obtains a third image; an object region determination unit for determining an object region by using a difference image between the first image and the second image; an object image extracting unit for extracting an object region image that corresponds to the determined object region from the third image; a storage unit for storing a background image; and an image superimposition unit for superimposing by overlaying the extracted object region image with a background image.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method of extracting an object for a sticker image according to an embodiment of the present invention;

FIG. 2 is a time graph regarding on/off of an infrared light according to an image frame signal;

FIG. 3 illustrates an arrangement of an infrared camera and a RGB camera by using a half mirror according to an embodiment of the present invention;

FIGS. 4 and 5 illustrate selection of a menu based on a hand which is an extracted object according to an embodiment of the present invention;

FIG. 6 is a flowchart illustrating a method of attaching a sticker according to an embodiment of the present invention;

FIG. 7 is a flowchart illustrating a method of attaching a sticker according to another embodiment of the present invention;

FIGS. 8 and 9 are block diagrams of an apparatus for extracting an object for a sticker image according to an embodiment of the present invention; and

FIG. 10 is a block diagram of an apparatus for attaching a sticker according to an embodiment of the present invention.

### DETAILED DESCRIPTION

The present invention will now be described more fully with reference to the accompanying drawings, in which exemplary embodiments of the invention are shown.

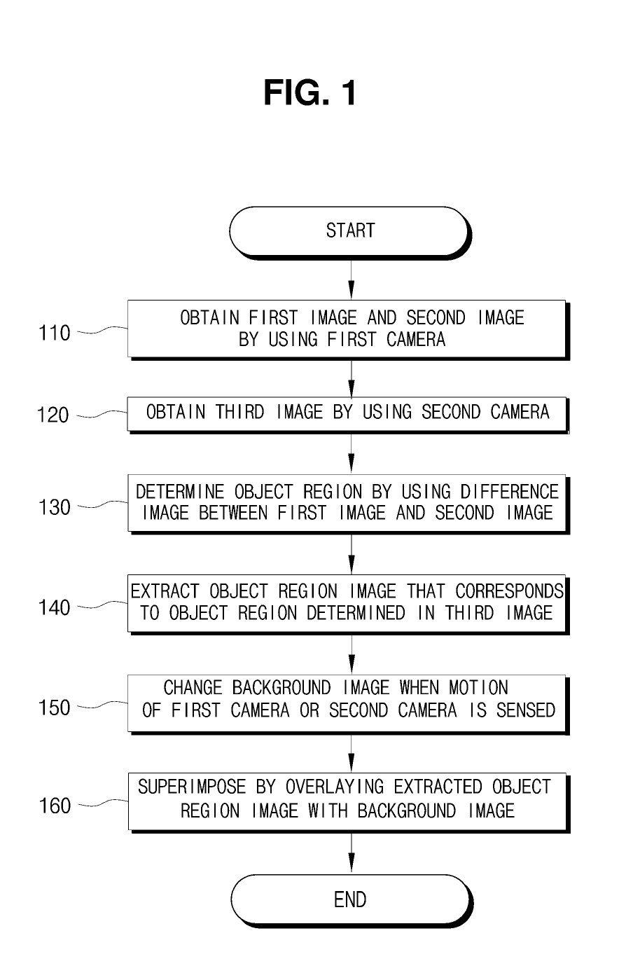

FIG. 1 is a flowchart illustrating a method of extracting an object for a sticker image according to an embodiment of the present invention.

Referring to FIG. 1, in an apparatus for performing a method of extracting an object for a sticker image (hereinafter, referred to as an apparatus for extracting an object), a first camera is used to obtain a first image and a second image, in operation 110. In the embodiment of the present invention, the first camera may be an infrared camera. Also, the first image is an image obtained by using an infrared camera by irradiating an infrared light and the second image is an image obtained by using an infrared camera without irradiating an infrared light. In order to separate an object or a background, a fact that an object is closer than a background is used in the embodiment of the present invention. When an infrared light is irradiated, a close object reflects more light. That is, the object that is close in the first image becomes an image reflecting more light.

The infrared light is on/off based on an image frame signal so as to obtain an image and a difference image is obtained as described below so as to extract an object region in real-time.

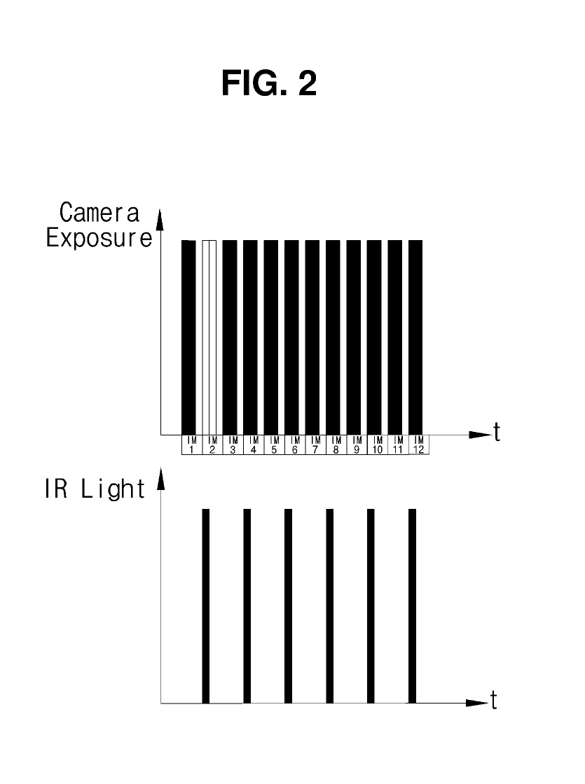

FIG. 2 is a time graph regarding on/off of an infrared light according to an image frame signal.

In the apparatus for extracting an object, a second camera is used to obtain a third image, in operation 120. In the embodiment of the present invention, the second camera may be a RGB camera and the third image is a real image obtained by using the RGB camera.

In the apparatus for extracting an object, a difference image between the first image and the second image is used to determine an object region, in operation 130. The first image obtained after irradiating an infrared light is an image, in which a close object reflects more light, and the second image obtained without irradiating an infrared light is an image, in which an object does not reflect light. Thus, when a difference between these two images is obtained, an image reflected by an infrared light, that is, an object image, remains. Therefore, only an image in an object region may be determined, or, conversely, only a background image except for an object region may be determined.

The apparatus for extracting an object determines a region, in which a bright change obtained after subtracting the second image from the first image is below a fixed critical value, as a background region and determines a region, in which the bright change is above a fixed critical value, as an object region.

According to the embodiment of the present invention, when an object region is a person's face, a fixed image technology is used to extract an object region by expanding the object region from the face to the body.

In operation 140, the apparatus for extracting an object extracts an object region image that corresponds to the object region determined in operation 130 from the third image. The apparatus for extracting an object may extract an object region image by extracting an object region image that corresponds to the object region determined in operation 130 from the third image or by removing a background region image that corresponds to the background region determined in operation 130 from the third image. According to the present invention, the apparatus for extracting an object may extract an object, that is, an image of a user, in real-time.

In extracting of an object region image, when the first camera and the second camera, that is, an infrared camera and a RGB camera, are arranged side by side, a time difference may generate. Accordingly, in the embodiment of the present invention, a half mirror is used to place a focus or a view of the first camera and a focus or a view of the second camera at the same axis, that is, to match. In this case, when a calibration work between the two cameras is performed beforehand, pixel matching between two images may be available.

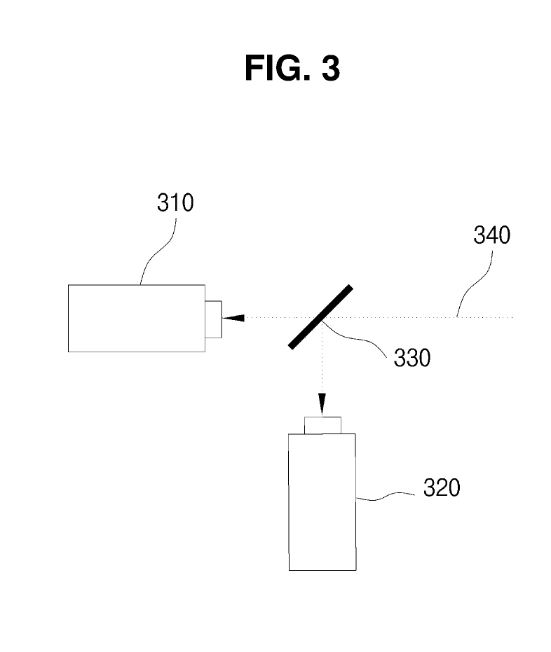

FIG. 3 illustrates an arrangement of an infrared camera and a RGB camera by using a half mirror according to an embodiment of the present invention.

Referring to FIG. 3, a focus 340 of a first camera 310 and a second camera 320 may be arranged at the same axis by using a half mirror 330, that is, to be matched.

In operation 150, when motion of any one of the first camera and the second camera is sensed, the apparatus for extracting an object changes a background image.

The apparatus for extracting an object provides a background image and makes a user select a desired background image by changing a background image when motion of the first camera or the second camera, or a device, to which the first camera or the second camera is adhered, for example, a smart phone or a digital signage, is sensed. In this case, since the background image is changed, it seems that an image is taken on the other place. The device, to which the first camera or the second camera is adhered, may change the background image according to not only motion but also a position change by using a gyro sensor.

The operation 150 may not be essentially performed in FIG. 1. That is, if the operation 150 is omitted, the present invention may be realized.

In operation 160, the apparatus for extracting an object overlays the extracted object region image with the background image and thereby, superimposes the object image on the background image.

In the present invention, a menu selection by using a hand gesture may be realized. A hand is extracted to the object region image and overlays with a background image, which is a menu screen. Then, a menu may be selected according to a position of the hand, that is, the object. Here, a menu may be selected more naturally than displaying of a hand on a screen by graphically reconfiguring the hand. Also, since an operation of graphically reconfiguring is not performed, computation of a processor is significantly reduced.

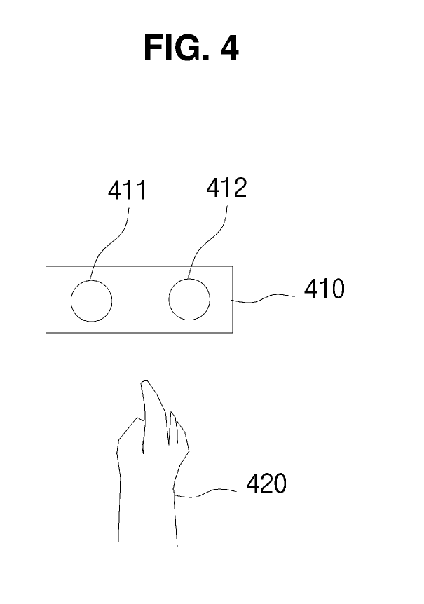

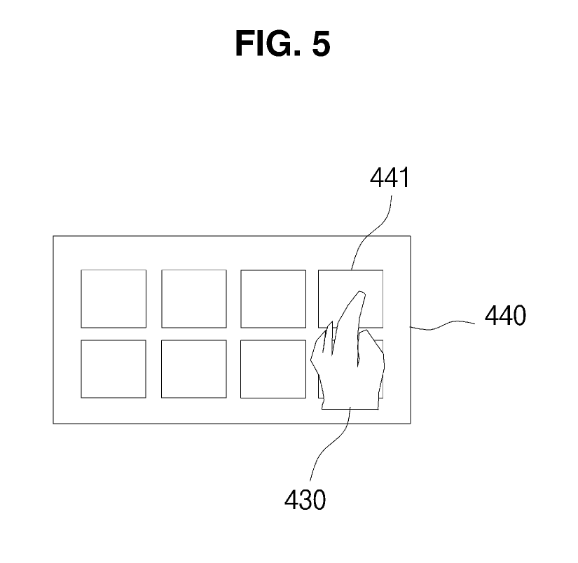

FIGS. 4 and 5 illustrate selection of a menu based on a hand which is an extracted object according to an embodiment of the present invention.

Referring to FIGS. 4 and 5, an apparatus for extracting an object 410 irradiates an infrared light by using a first camera 411 so as to obtain a first image relating to a hand 420, which is an object, and does not irradiate an infrared light so as to obtain a second image relating to the hand 420. Then, a difference image is obtained based on the first and second images so as to determine an object region relating to the hand 420. Also, a second camera 412 is used to obtain a third image and an object extracted image (430 of FIG. 5) relating to the determined object region is obtained. Then, the object extracted image 430 overlays with a background image 440 as in FIG. 5. The background image 440 includes 8 menu items and the object extracted image 430 may select any one 441 of the menu items.

When such a technology is used, image processing for searching for a fingertip may be easy so that a menu selection algorithm may be simply realized and reliability thereof may increase. In this case, since an infrared light is on/off to extract an object image, the apparatus for extracting an object may not be affected by an external light source and thus, may be operated in an outdoor environment or at night. Such technology may be used in controlling of a menu in a car. Also, an interface may be naturally established by using a real-image of a user's hand in virtual reality or a man-machine interface in augmented reality contents.

In FIG. 1, an object image may be extracted in real-time. For example, a user standing in front of a smart phone or a digital signage may be separated from a background in real-time and may be superimposed on a new background. In this case, it seems that a user stands at the other place. A commercial screen may be used as a background or the user may be superimposed on a movie screen, graphic, theater or other existing photos or video clip. In addition, such technology may be applicable to a video conference. When in a smart phone, various self-cameras may be available and when in a game, such technology may be applicable to virtual reality or in augmented reality games.

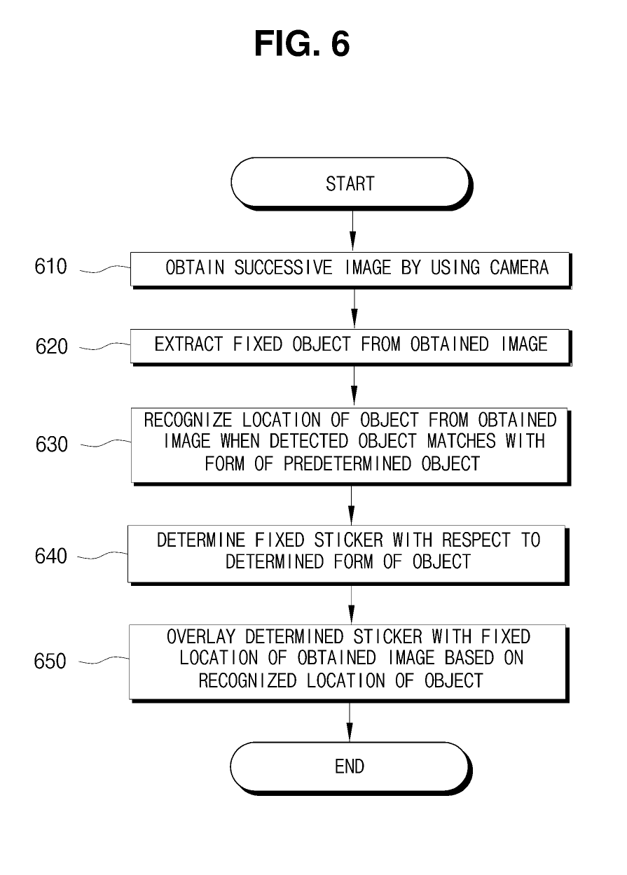

FIG. 6 is a flowchart illustrating a method of attaching a sticker according to an embodiment of the present invention. Referring to FIG. 6, an apparatus for performing a method of attaching a sticker (hereinafter, referred to as an apparatus for attaching a sticker) obtains successive images by using a camera, in operation 610. The apparatus for attaching a sticker may be adhered to a smart phone including a camera or a digital signage.

In operation 620, the apparatus for attaching a sticker detects a fixed object from the obtained image. In the embodiment of the present invention, the object may be a hand. Also, the object may be a face and may not be limited, if it is already determined.

In operation 630, when the detected object matches with a form of the predetermined object, the apparatus for attaching a sticker recognizes a location of an object in the obtained image. For example, when the object is a hand, a form of the object may be a hand gesture such as rock-paper-scissors or a finger heart. In the embodiment of the present invention, not only a location of the object but also a size of the object may be recognized from the obtained image.

The form of the predetermined object is determined beforehand through pattern recognition by obtaining a specific value using image analysis after collecting images corresponding to the predetermined object.

In operation 640, the apparatus for attaching a sticker determines a fixed sticker with respect to the determined form of the object. For example, when the form of the object is a finger heart, a heart-shaped sticker is determined.

When the size of the object is recognized from the obtained image, a size of the determined sticker may be changed according to a size of the recognized object.

In operation 650, the determined sticker overlays with a fixed location of the obtained image based on the recognized location of the object. For example, when the form of the object is a finger heart, the heart-shaped sticker may be overlaid with the finger heart in the obtained image.

In FIG. 6, a user does not determine a sticker and instead, a sticker is automatically determined according to a type of an object. Thus, users' convenience increases. Also, since a sticker is inserted into a specific location based on a type of an object, there may be effective in terms of design and a sticker may be attached to a desired location at desired time.

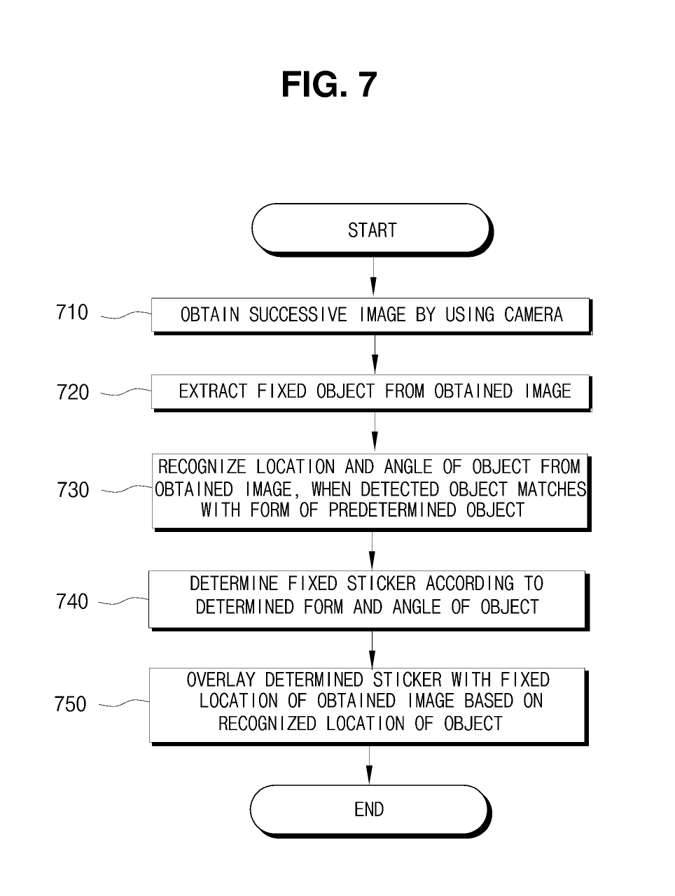

FIG. 7 is a flowchart illustrating a method of attaching a sticker according to another embodiment of the present invention.

Referring to FIG. 7, an apparatus for attaching a sticker obtains successive images by using a camera, in operation 710. The apparatus for attaching a sticker may be adhered to a smart phone or a digital signage.

In operation 720, the apparatus for attaching a sticker detects a fixed object from the obtained image. In the embodiment of the present invention, the object may be a hand. Also, the object may be a face and may not be limited, if it is already determined

In operation 730, when the detected object matches with a form of the predetermined object, the apparatus for attaching a sticker recognizes a location and an angle of an object in the obtained image. The angle of the recognized object obtained from a form of a standard object. In another embodiment, since successive images are obtained, the object recognized from the successive images is tracked to calculate rotating 3-axis angle and a rotation angle may be recognized.

In the embodiment of the present invention, not only a location of the object but also a size of the object may be recognized from the obtained image.

The form of the predetermined object is determined beforehand through pattern recognition by obtaining a specific value using image analysis after collecting images corresponding to the predetermined object.

In operation 740, the apparatus for attaching a sticker determines a fixed sticker based on an angle of the detected object with respect to the determined form of the object. In the present invention, as a sticker may rotate according to an angle of an object, not only 2D stickers but also 3D stickers may be used. In this case, 3D stickers move as an object moves, thereby rousing user's interest.

Also, when the sticker determined according to motion occurring due to rotation of the object is superimposed by frames, a video sticker image may be realized.

When a size of the object is recognized from the obtained image, a size of the determined sticker may be changed according to a size of the recognized object.

In operation 750, the determined sticker overlays with a fixed location of the obtained image based on a recognized location of the object.

In FIG. 7, the sticker may rotate according to an angle of the object so as to realize in various ways. Also, the method of FIG. 7 may be applied to a 3D sticker and thus, a moving effect sticker may be realized so as to be superimposed on a desired location.

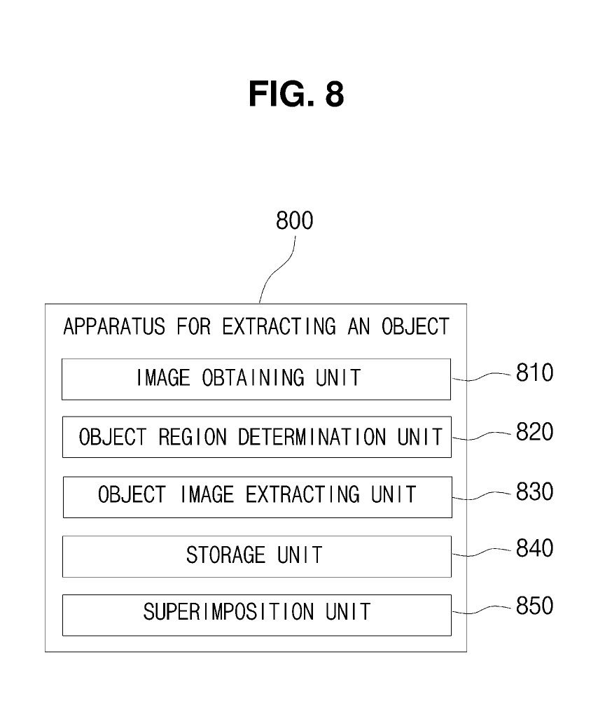

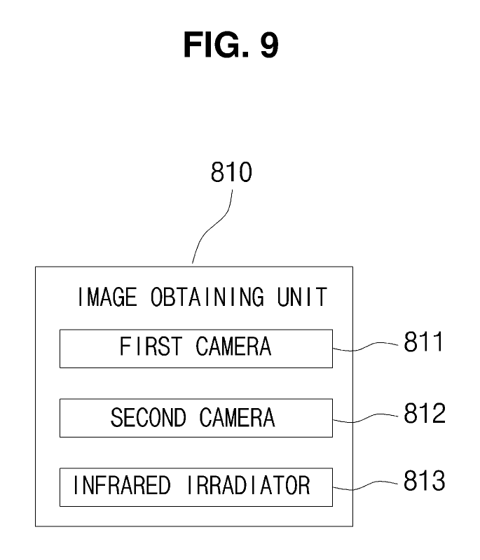

FIGS. 8 and 9 are block diagrams of an apparatus 800 for extracting an object for a sticker image according to an embodiment of the present invention

Referring to FIGS. 8 and 9, the apparatus 800 for extracting an object includes an image obtaining unit 810, an object region determination unit 820, an object image extracting unit 830, a storage unit 840, and a superimposition unit 850. The image obtaining unit 810 includes a first camera 811, a second camera 812, and an infrared irradiator 813.

The apparatus 800 for extracting an object obtains first image and a second image by using the first camera 811. In the embodiment of the present invention, the first camera 811 may be an infrared camera. Also, the first image is an image obtained by using an infrared camera by irradiating an infrared light from the infrared irradiator 813 and the second image is an image obtained by using an infrared camera without irradiating an infrared light. In order to separate an object or a background, a fact that an object is closer than a background is used in the embodiment of the present invention. When an infrared light is irradiated, a close object reflects more light. That is, the object that is close in the first image becomes an image reflecting more light.

The image obtaining unit 810 obtains an image by using the infrared irradiator 813 which turns an infrared light on/off based on an image frame signal and obtains a difference image as described below so as to extract an object region in real-time.

The apparatus 800 for extracting an object obtains a third image by using the second camera 812 of the image obtaining unit 810. In the embodiment of the present invention, the second camera 812 is a RGB camera and the third image is a real image obtained by using the RGB camera.

The object region determination unit 820 determines an object region by using the difference image between the first image and the second image. The first image obtained after irradiating an infrared light is an image, in which a close object reflects more light, and the second image obtained without irradiating an infrared light is an image, in which an object does not reflect light. Thus, when a difference between these two images is obtained, an image reflected by an infrared light, that is, an object image, remains. Therefore, the object region determination unit 820 may determine only an image in an object region or, conversely, only a background image except for an object region. The apparatus 800 for extracting an object determines a region, in which a bright change obtained after subtracting the second image from the first image is below a fixed critical value, as a background region and determines a region, in which the bright change is above a fixed critical value, as an object region.

According to the embodiment of the present invention, when an object region is a person's face, a fixed image technology is used to extract an object region by expanding the object region from the face to the body.

The object image extracting unit 830 extracts an object region image that corresponds to the object region determined in the object region determination unit 820 from the third image. The object image extracting unit 830 may extract an object region image by extracting an object region image that corresponds to the object region determined in operation 130 from the third image or by removing a background region image that corresponds to the background region determined in operation 130 from the third image. According to the present invention, the apparatus 800 for extracting an object may extract an object, that is, an image of a user, in real-time.

In extracting of an object region image, when the first camera 811 and the second camera 812, that is, an infrared camera and a RGB camera, are arranged side by side, a time difference may generate. Accordingly, in the embodiment of the present invention, a half mirror is used to place a focus or a view of the first camera 811 and a focus or a view of the second camera 812 at the same axis, that is, to match. In this case, when a calibration work between the two cameras is performed beforehand, pixel matching between two images may be available.

FIG. 3 illustrates an arrangement of an infrared camera and a RGB camera by using a half mirror according to an embodiment of the present invention.

When motion of any one of the first camera 811 and the second camera 812 is sensed, the superimposition unit 850 changes a background image. The storage unit 840 provides a background image and makes a user select a desired background image by changing a background image when motion of the first camera 811 or the second camera 812, or a device, to which the first camera 811 or the second camera 812 is adhered, for example, a smart phone or a digital signage, is sensed. In this case, since the background image is changed, it seems that an image is taken on the other place. The device, to which the first camera 811 or the second camera 812 is adhered, may change the background image according to not only motion but also a position change by using a gyro sensor.

The superimposition unit 850 overlays the extracted object region image with the background image and thereby, superimposes the object image on the background image.

In the present invention, a menu selection by using a hand gesture may be realized. A hand is extracted to the object region image and overlays with a background image, which is a menu screen. Then, a menu may be selected according to a position of the hand, that is, the object. Here, a menu may be selected more naturally than displaying of a hand on a screen by graphically reconfiguring the hand. Also, since an operation of graphically reconfiguring is not performed, computation of a processor is significantly reduced.

When such a technology is used, image processing for searching for a fingertip may be easy so that a menu selection algorithm may be simply realized and reliability thereof may increase. In this case, since an infrared light is on/off to extract an object image, the apparatus for extracting an object may not be affected by an external light source and thus, may be operated in an outdoor environment or at night. Such technology may be used in controlling of a menu in a car. Also, an interface may be naturally established by using a real-image of a user's hand in virtual reality or a man-machine interface in augmented reality contents.

In the embodiment of the present invention, an object image may be extracted in real-time. For example, a user standing in front of a smart phone or a digital signage may be separated from a background in real-time and may be superimposed on a new background. In this case, it seems that a user stands at the other place. A commercial screen may be used as a background or the user may be superimposed on a movie screen, graphic, theater or other existing photos or video clip. In addition, such technology may be applicable to a video conference. When in a smart phone, various self-cameras may be available and when in a game, such technology may be applicable to virtual reality or in augmented reality games.

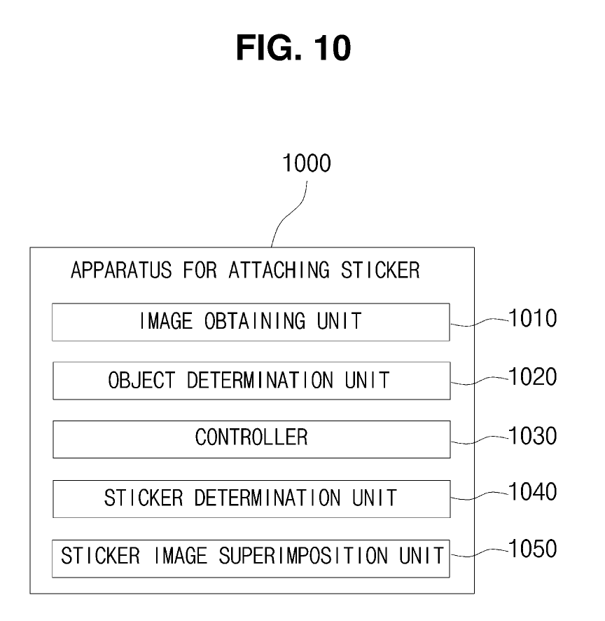

FIG. 10 is a block diagram of an apparatus 1000 for attaching a sticker according to an embodiment of the present invention.

Referring to FIG. 10, the apparatus 1000 for attaching a sticker includes an image obtaining unit 1010, an object determination unit 1020, a controller 1030, a sticker determination unit 1040, and a sticker image superimposition unit 1050.

The image obtaining unit 1010 obtains successive images by using a camera. The apparatus 1000 for attaching a sticker may be adhered to a smart phone including a camera or a digital signage.

The object determination unit 1020 detects a fixed object from the obtained image. In the embodiment of the present invention, the object may be a hand. Also, the object may be a face and may not be limited, if it is already determined.

When the detected object matches with a form of the predetermined object, the controller 1030 recognizes a location of an object in the obtained image. For example, when the object is a hand, a form of the object may be a hand gesture such as rock-paper-scissors or a finger heart. In the embodiment of the present invention, not only a location of the object but also a size of the object may be recognized from the obtained image.

The form of the predetermined object is determined beforehand through pattern recognition by obtaining a specific value using image analysis after collecting images corresponding to the predetermined object.

The sticker determination unit 1040 determines a fixed sticker with respect to the determined form of the object. For example, when the form of the object is a finger heart, a heart-shaped sticker is determined.

When the size of the object is recognized from the obtained image, the sticker determination unit 1040 may change a size of the determined sticker according to a size of the recognized object.

The sticker image superimposition unit 1050 overlays the determined sticker with a fixed location of the obtained image based on a recognized location of the object. For example, when the form of the object is a finger heart, the heart-shaped sticker may be overlaid with the finger heart in the obtained image.

Here, a user does not determine a sticker and instead, a sticker is automatically determined according to a type of an object. Thus, users' convenience increases. Also, since a sticker is inserted into a specific location based on a type of an object, there may be effective in terms of design and a sticker may be attached to a desired location at desired time.

A method of attaching a sticker according to another embodiment of the present invention will be described.

When the object matches with a form of the predetermined object, the controller 1030 recognizes a location and an angle of an object in the obtained image. The angle of the recognized object obtained from a form of a standard object. In another embodiment, since successive images are obtained, the controller 1030 tracks the object recognized from the successive images to calculate rotating 3-axis angle and a rotation angle may be recognized.

Also, not only a location of the object but also a size of the object may be recognized from the obtained image.

The form of the predetermined object is determined beforehand through pattern recognition by obtaining a specific value using image analysis after collecting images corresponding to the predetermined object.

As the sticker determination unit 1040 may rotate a sticker according to an angle of an object, not only 2D stickers but also 3D stickers may be used. In this case, 3D stickers move as an object moves, thereby rousing user's interest.

Also, when the sticker determined according to motion occurring due to rotation of the object is superimposed by frames, the sticker determination unit 180 may realize a video sticker image.

Here, the sticker may rotate according to an angle of the object so as to realize in various ways. Also, the method may be applied to a 3D sticker and thus, a moving effect sticker may be realized so as to be superimposed on a desired location.

According to the present invention, an object image may be extracted in real-time. For example, a user standing in front of a smart phone or a digital signage may be separated from a background in real-time and may be superimposed on a new background. In this case, it seems that a user stands at the other place. A commercial screen may be used as a background or the user may be superimposed on a movie screen, graphic, theater or other existing photos or video clip. In addition, such technology may be applicable to a video conference. When in a smart phone, various self-cameras may be available and when in a game, such technology may be applicable to virtual reality or in augmented reality games.

Also, according to the present invention, a user does not determine a sticker and instead, a sticker is automatically determined according to a type of an object. Thus, users' convenience increases. Also, since a sticker is inserted into a specific location based on a type of an object, there may be effective in terms of design and a sticker may be attached to a desired location at desired time.

In addition, according to the present invention, the sticker may rotate according to an angle of the object so as to realize in various ways. Also, the method may be applied to a 3D sticker and thus, a moving effect sticker may be realized so as to be superimposed on a desired location.

The method of extracting an object and the method of attaching a sticker as described above can be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of extracting an object for a sticker image comprising:
obtaining a first image and a second image by using a first camera;
obtaining a third image by using a second camera;
determining an object region by using a difference image between the first image and the second image;
extracting an object region image that corresponds to the determined object region from the third image; and
superimposing by overlaying the extracted object region image with a background image.

2. The method of claim 1, wherein the first camera is an infrared camera and the second camera is a RGB camera and wherein the first image is an image obtained by using an infrared camera by irradiating an infrared light and the second image is an image obtained by using an infrared camera without irradiating an infrared light.

3. The method of claim 2, wherein the determining an object region by using a difference image between the first image and the second image comprises determining a region, in which a bright change obtained after subtracting the second image from the first image is below a fixed critical value, as a background region and a region, in which the bright change is above a fixed critical value, as an object region and the extracting an object region image that corresponds to the determined object region from the third image comprises extracting an object region image except for the region that corresponds to the background region determined from the third image.

4. The method of claim 2, wherein a focus of the first camera and a focus of the second camera are placed at the same axis by using a half mirror.

5. The method of claim 2, further comprising changing the background image when motion of any one of the first camera and the second camera is sensed.

6. The method of claim 2, wherein the object region image is a hand image and the background image is a menu.

7. An apparatus for extracting on object for a sticker image, the apparatus comprising:
an image obtaining unit comprising a first camera, which obtains a first image and a second image, and a second camera, which obtains a third image;
an object region determination unit for determining an object region by using a difference image between the first image and the second image;
an object image extracting unit for extracting an object region image that corresponds to the determined object region from the third image;
a storage unit for storing a background image; and
an image superimposition unit for superimposing by overlaying the extracted object region image with a background image.

8. The apparatus of claim 7, wherein the first camera is an infrared camera and the second camera is a RGB camera and wherein the first image is an image obtained by using an infrared camera by irradiating an infrared light and the second image is an image obtained by using an infrared camera without irradiating an infrared light.

9. The apparatus of claim 8, wherein the object region determination unit determines a region, in which a bright change obtained after subtracting the second image from the first image is below a fixed critical value, as a background region and a region, in which the bright change is above a fixed critical value, as an object region and wherein the object image extracting unit extracts an object region image except for the region that corresponds to the background region determined from the third image.

10. The apparatus of claim 8, wherein a focus of the first camera and a focus of the second camera are placed at the same axis by using a half mirror.

11. The apparatus of claim 8, wherein the image superimposition unit changes the background image when motion of any one of the first camera and the second camera is sensed.

12. The apparatus of claim 8, wherein the object region image is a hand image and the background image is a menu.
